(19) United States
(12) Patent Application Publication
(10) Pub. No.: US 2007/0123415 A1
(43) Pub. Date: May 31, 2007

(54) Process for production of mesoporous structures

(75) Inventors: Hiroaki Yotoh, Kariya-city (JP); Miho Ito, Hoi-gun (JP); Takumi Okamoto, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/602,708

(22) Filed: Nov. 21, 2006

(30) Foreign Application Priority Data
Nov. 29, 2005 (JP) 2005-343633
May 8, 2006 (JP) 2006-129215
Oct. 20, 2006 (JP) 2006-286433

(51) Int. Cl. B01J 23/10

(52) U.S. Cl. 502/235; 423/335; 423/263

(57) ABSTRACT

A process for production of a mesoporous structure wherein fine particles having a mean particle size smaller than the size of pores of a mesoporous body formed using a template are formed in the pores of the mesoporous body. The process comprises the steps of: preparing an aqueous solution comprising a mixture of the template and the fine particles, heating and pressurizing the aqueous solution to bring the water in the aqueous solution to a subcritical water state, returning the aqueous solution to a state at a room temperature and under atmospheric pressure, dissolving the starting material of the mesoporous body in the aqueous solution and heating it to form a precipitate comprising the template, fine particles and starting material of the mesoporous body, and separating, drying and firing the precipitate to burn off the template from the precipitate.

### BACKGROUND OF THE INVENTION

1. Field of the Invention

The present invention relates to a process for production of a mesoporous structure having fine particles contained in pores of a mesoporous body. The present invention relates to, for example, catalyst structures used for automobile exhaust purification, fuel cells and environmental cleanup, or to structures used for adsorbents, magnetic materials, electrode materials, optoelectronic devices and biochemical sensors.

2. Description of the Related Art

Precious metals such as Pt, Pd and Rh are used as catalysts for purification of noxious components such as HC, CO and NOx in automobile exhaust gas, for example. Such catalytic precious metals are supported as particles on the surface of a carrier such as alumina in order to increase the contact area with exhaust gas for purification of the noxious components.

In recent years, exhaust gas standards for automobiles and the like have become more stringent, and a demand exists for higher efficiency purification of noxious components by exhaust gas purification catalysts. Similarly, a need exists for further improvement in the purification performance and function of fuel cell catalysts and environmental cleanup catalysts, and the development of more highly active catalysts is anticipated.

Strategies that have been proposed for improving the efficiency of precious metal catalysts include development of precious metal particles on the nanometer order with large contact areas, obtained by working precious metal particles into fine particles to increase the contact area with noxious components and the like. One of such strategies has been proposed for catalytic particles with higher activity and with activity for multiple substances to allow effective purification in small amounts (see Japanese Unexamined Patent Publication (Kokai) No. 2003-80077).

This provides fine particles consisting of nanocomplex catalyst particles, i.e. catalyst particles comprising base particles that are one type of simple. fine particle or two or more types of solid solution fine particles having a mean particle size (primary particle size) on the nanometer order, and a metal catalyst covering at least portions of the surfaces of the base particles.

Such nanocomplex catalyst particles have a three-dimensional structure on the nanometer order wherein a metal catalyst is situated on the surfaces of base particles on the nanometer order, and therefore the area-to-weight ratio is high and high catalytic activity is realized.

However, when the aforementioned nanocomplex catalyst particles are actually-used for purification of exhaust gas, it has not been possible to support the nanocomplex catalyst particles on the carrier with sufficient dispersibility by conventional supporting methods, and hence the performance of nanocomplex catalyst particles cannot be fully realized.

To avoid this problem, a mesoporous structure has been proposed which has nanocomplex catalyst particles situated in the pores of the mesoporous body as fine particles with a mean particle size smaller than the sizes of the pores (see Japanese Unexamined Patent Publication (Kokai) No. 2005-152725).

Here, the-term “mesoporous body” is defined academically as those having pores of sizes between from 5 nm to less than 50 nm. The mesoporous body has pore sizes large enough to allow the nanocomplex catalyst particles to be supported with high dispersibility, as well as a large pore volume per unit weight. This type of mesoporous body is usually formed from a metal oxide or the like with a template, i.e. by the template method.

Specifically, the template method is carried out as follows. The starting material of the mesoporous body composed of a metal oxide or the like is dissolved in an aqueous solution of a template composed of a surfactant, and is heated. Upon heating, hydrolysis is caused whereby the starting material of the mesoporous body adheres around the perimeter of the template.

Then, the template to which the starting material has adhered aggregates due to the property of the surfactant, forming an aggregate or self-assembling structure. The aggregate is then precipitated. The precipitate is separated and then dried and fired to burn off the template from the precipitate. This creates pores in the spaces remaining after burning off the template, forming a mesoporous body.

In the production process described in Japanese Kokai No. 2005-152725, a surfactant is mixed with the aqueous solution containing the starting material of the fine particle as the nanocomplex base particles, in order to prepare a mixture with the fine particles enveloped by the surfactant to form a reversed micelle state, and after impregnating the mixture into the pores of the mesoporous body, the mesoporous body is dried and fired to produce a mesoporous structure.

However, since in the production process described in Japanese Kokai No. 2005-152725, the reversed micelle state is formed by enveloping the fine particles with the surfactant, the sizes of the reversed micelles are larger than the sizes of the original fine particles.

Consequently, the reversed micelles containing the fine particles can be difficult to introduce into the pores of the mesoporous body, making it difficult to efficiently place the fine particles in the pores of the mesoporous body.

### SUMMARY OF THE INVENTION

It is an object of the present invention to provide a process for production of a mesoporous structure wherein fine particles are situated in the pores of a mesoporous body formed by the template method, whereby they can be situated in the pores efficiently without converting the fine particles to a reversed micelle state.

The present inventors have conducted much diligent research with the aim of achieving this object. As a result, we conceived in the production of a mesoporous structure by the template method, with application of a previous integration of the template used as a mold to form the mesoporous body and the fine particles.

By using a template as a mold obtained by integrating the template and the fine particles, the fine particles remain in the pores of the mesoporous body as the template is burned off during firing, resulting in the fine particles being situated in the pores.

As a result of further examination, it was discovered through experimentation that if an aqueous solution obtained by mixing the fine particles with an aqueous solution of the template is prepared and the aqueous solution is converted to subcritical water, it is possible to form a template wherein the fine particles are embedded in the self-assembling structure of the template.

Here, “subcritical water” is hot water at low pressure at a temperature near the critical point, as illustrated in FIG. 4 described hereunder, and it exhibits excellent seepage force and a powerful hydrolytic effect when the aqueous solution is at low viscosity.

In order to bring water to this subcritical water state, it is necessary to carry out heating and. pressurization of the water for a high-temperature and high-pressure atmosphere in the subcritical region. Specifically, there are known methods such as hydrothermal synthesis treatment, ultrasonic irradiation wherein the water is irradiated with ultrasonic waves and the impact energy from bursting of the air bubbles generated thereby is utilized, and microwave irradiation wherein the impact occurring with irradiation of the water with microwaves is utilized.

The present inventors therefore considered that subjecting an aqueous solution comprising a mixture of a template and fine particles to heating and pressurization by such hydrothermal synthesis treatment, ultrasonic irradiation or microwave irradiation can create a subcritical water state with the water in the aqueous solution, in order to form a precursor wherein the template and fine particles are integrated.

Also, it was found that if a starting material of the mesoporous body is mixed with an aqueous solution subjected to treatment to create subcritical water and then the precipitate is separated, dried and fired according to the conventional template method, it is possible to form a mesoporous structure wherein fine particles are situated in the pores of the mesoporous body.

The present invention has been discovered as a result of the experimental analysis described above, and it is characterized by heating and pressurizing an aqueous solution comprising a mixture of a template and fine particles to bring the water in the aqueous solution to a subcritical water state, returning the aqueous solution to a state at a room temperature and under atmospheric pressure, dissolving the starting material of the mesoporous body in the aqueous solution and heating it to form a precipitate comprising the template, fine particles and starting material of the mesoporous body, and then separating, drying and firing the precipitate to burn off the template from the precipitate.

According the present method, it becomes possible to efficiently situate the fine particles in the pores without forming a reversed micelle state.

In the practice of the present invention, an amphiphilic poly(alkylene oxide) block copolymer can be used as the template. It is preferred that the poly(alkylene oxide) block copolymer has a molecular weight of 1,000 or more.

Especially, as the block polymer, it can be selected from the group consisting of triblock copolymers having hydrophilic poly(alkylene oxide) covalently bonded to the opposed ends of hydrophobic poly(alkylene oxide), and diblock copolymers having hydrophobic poly(alkylene oxide) covalently bonded to the end terminal of hydrophilic poly(alkylene oxide).

It is preferred that hydrophilic poly(alkylene oxide) is poly(ethylene oxide), and hydrophobic poly(alkylene oxide) is selected from the group consisting of poly(propylene oxide), poly(butylene oxide), poly(phenylene oxide) and polyhydroxylic acid.

Further, it is effective that hydroxylic acid is glycolic acid, lactic acid, malic acid, tartaric acid or citric acid.

More especially, the block copolymer includes, for example, a triblock copolymer (EOx-POy-EOx) in which hydrophilic poly(alkylene oxide) such as poly(ethylene oxide) (EOx) is covalently bonded to the opposed ends of hydrophobic poly(alkylene oxide) such as poly(propylene oxide) (POy), and others. In the above formula, x and y each means a polymerization grade of the polymer. For example, when the formula is represented by EO20-PO70-EO20, it means that a polymerization grade of EO is 20 and that of PO is 70.

When used herein, hydrophilic poly(alkylene oxide) has both of the function of dissolving the block copolymer in an aqueous solution, and the function of reacting with a starting material capable of forming a mesoporous body to thereby form a bone or skeleton of the mesoporous body. Further, hydrophobic poly(alkylene oxide) has the function of acting as a template or mold for forming the mesoporous body.

To attain these functions, it is, of course, essentially required that the hydrophilic and hydrophobic poly(alkylene oxide) are integrally combined to form the mesoporous body. Moreover, to dissolve these poly(alkylene oxide) in the aqueous solution, it is desired that hydrophilic poly(alkylene oxide) is contained in the mixture in an amount of 30 to 60%.

Further, in the aqueous solution comprising the mixture of the template and fine particles, the molar ratio of the template and fine particles is preferably not greater than 20 for the fine particles with respect to 1 for the template, and more preferably not greater than 10 for the fine particles with respect to 1 for the template.

When preparing the precursor wherein the template and fine particles are integrated, an organic substance containing a functional group with high affinity for the template and fine particles, such as carboxyl, carbonyl, ether, amino or the like, is added to form a precursor having nanoparticles enveloped in the self-assembling structure of the template, to efficiently anchor the nanoparticles in the pores of the mesoporous body.

As a result of further experimental, analysis, it was found that by also adding a molecule with a functional group that attracts at each other the template by hydrophobic interaction and a functional group that attracts at each other the fine particles by electrostatic attraction in the aqueous solution comprising the mixture of the template and fine particles, the molecule facilitates envelopment of the fine particles by the template.

The numbers in parentheses used in the following description correspond to the specific means of the embodiments described below.

### BRIEF DESCRIPTION OF THE DRAWINGS

FIGS. 1A and 1B are a pair of illustrations showing the general structure of a mesoporous structure according to an embodiment of the invention, where FIG. 1A is a perspective view and FIG. 1B is a cross-sectional view,

FIGS. 2A and 2B are,a pair of cross-sectional views schematically showing the structure of fine particles according to the above embodiment,

FIGS. 3A to 3E each is a cross-sectional view that schematically illustrates, in sequence, a production process for the mesoporous structure of the above embodiment, and

FIG. 4 is a state diagram for water with regard to the temperature vs. pressure.

### DESCRIPTION OF THE PREFERRED EMBODIMENTS

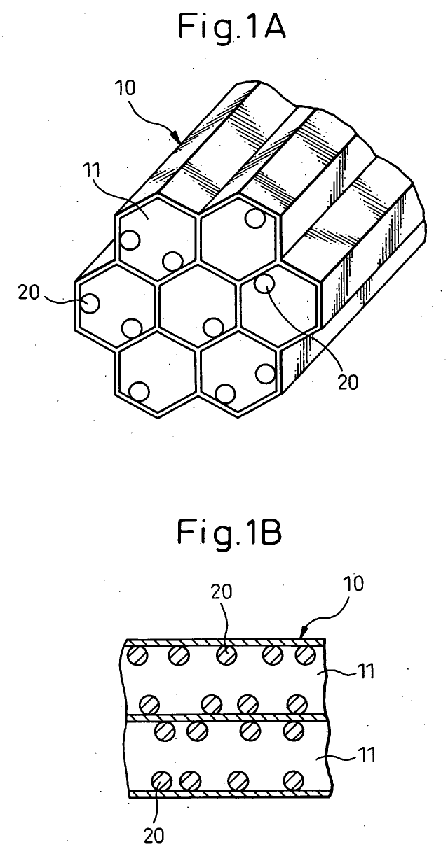

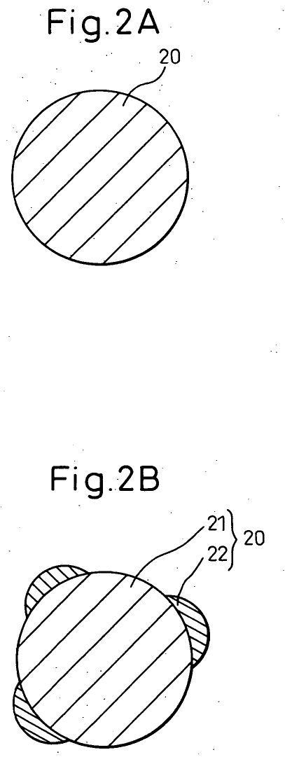

Preferred embodiments of the present invention will now be explained with reference to the accompanying drawings. FIGS. 1A and 1B are a pair of illustrations of the general structure of a mesoporous structure 100 according to an embodiment of the invention, where FIG. 1A is a perspective view and FIG. 1B is a cross-sectional view. FIGS. 2A and 2B are a pair of illustrations schematically showing the structure of fine particles 20 according to this embodiment.

In FIGS. 1A and 1B, the mesoporous body 10 has pores 11 of sizes of from 5 nm to less than 50 nm. In the illustrated embodiment, the pores 11 are hexagonally shaped holes, but this is not limitative and the shapes of the pores 11 may instead be, for example, round, quadrangular or the like.

The mesoporous body 10 is composed of a metal oxide, and the metal of the metal oxide is a single type selected from among-Ce, Zr, Al, Ti, Si, Mg, W, Fe, Sr, Y, Nb and P, or a solid solution of two or more of these. For this embodiment, the mesoporous body 10 is made of silica.

Fine particles 20 are situated in the pores 11 of the mesoporous body 10. The fine particles 20 are situated in a manner with some in the inner walls of the pores 11 of the mesoporous body 10, or adsorbed onto the surfaces of the inners walls of the pores 11.

The fine particles 20 have primary particles with a mean particle size that is smaller than the diameter of the pores 11 of the mesoporous body 10, and for example, they have a mean particle size of about 1 to 50 nm. Also, for example, the mean particle size of the fine particles 20 is about 80% or less smaller than the diameters of the pores 11.

The fine particles 20 may be simple particles as shown in FIG. 2A, or they may have covering layers 22 formed around the outer perimeter of cores 21 as shown in FIG. 2B.

As fine particles 20 of the type shown in FIG. 2A there may be mentioned metal oxides of Ce, Ce—Zr, Ti, Zr and the like. As fine particles 20 of the type shown in FIG. 2B there may be mentioned the nanocomplex catalyst particles described in Japanese Kokai No. 2003-80077.

Specifically, referring to Japanese Kokai No. 2003-80077, the nanocomplex catalyst particles of this embodiment may comprise, for example, covering layers 23 made of a precious metal or metal oxide of Pt, Pd, Rh, Ir, Ru or the like adhered onto the surfaces of cores 21 made of a metal oxide of Ce, Zr, Al, Ti, Si or the like.

Thus, the mesoporous structure 100 of this embodiment has a mesoporous body 10 comprising pores 11 with diameters of from 5 nm to less than 50 nm, wherein fine particles 20 with a mean particle size that is smaller than pores 11 are situated in the pores 11. The mesoporous structure 100 has an overall size of 1.0 μm or smaller.

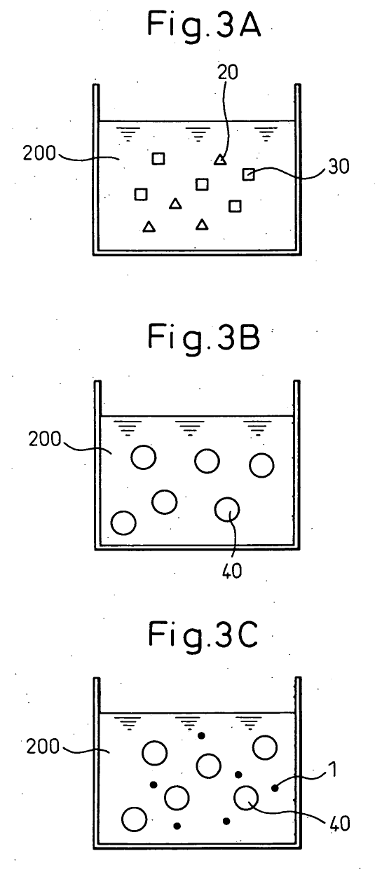

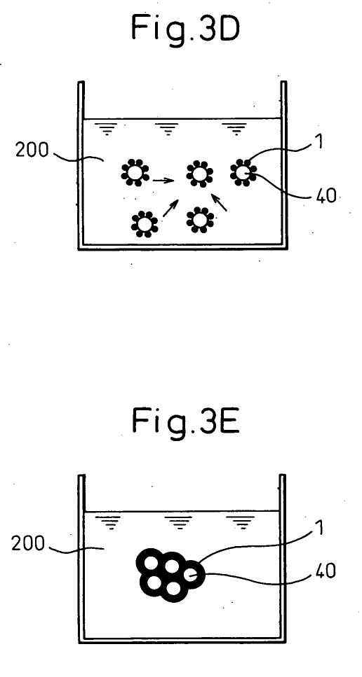

A process for production of the mesoporous structure 100 will now be explained. FIGS. 3A to 3E each is a process diagram that schematically illustrates, in sequence, the production process. The production process makes use of the template method for formation of a mesoporous body using a conventional template.

First, as shown in FIG. 3A, an acidic (for example, approximately pH=1) aqueous solution 200 is prepared comprising a mixture of the template 30 and the fine particles 20. The fine particles 20 may be produced by the method described in Japanese Kokai No. 2003-80077, for example.

In this method, a conventional amphiphilic poly(alkylene oxide) block copolymer can be used as the template. A molecular weight of the poly(alkylene oxide) block copolymer is preferably 1,000 or more.

Desirably, as the above block polymer, it can be selected from triblock copolymers having hydrophilic poly(alkylene oxide) covalently bonded to the opposed ends of hydrophobic poly(alkylene oxide), and diblock copolymers having hydrophobic poly(alkylene oxide) covalently bonded to the end terminal of hydrophilic poly(alkylene oxide).

Poly(ethylene oxide) can be used as hydrophilic poly(alkylene oxide), and poly(alkylene oxide) can be selected from poly(propylene oxide), poly(butylene oxide), poly(phenylene oxide) and polyhydroxylic acid as hydrophobic poly(alkylene oxide).

Further, glycolic acid, lactic acid, malic acid, tartaric acid and citric acid are effective as hydroxylic acid.

More especially, the block copolymer includes, for example, a triblock copolymer (EOx-POy-EOx) in which hydrophilic poly(alkylene oxide) such as poly(ethylene oxide) (EOx) is covalently bonded to the opposed ends of hydrophobic poly(alkylene oxide) such as poly(propylene oxide) (POy), and others. In this formula, x and y each means a polymerization grade of the polymer. For example, when the formula is represented by EO20-PO70-EO20, it means that a polymerization grade of EO is 20 and that of PO is 70.

Here, hydrophilic poly(alkylene oxide) has both of the function of dissolving the block copolymer in an aqueous solution, and the function of reacting with a starting material capable of forming a mesoporous body to thereby form a bone or skeleton of the mesoporous body. Further, hydrophobic poly(alkylene oxide).has the function of acting as a template or mold for forming the mesoporous body.

Of course, it is essentially required that the hydrophilic and hydrophobic poly(alkylene oxide) are integrally combined to form the mesoporous body. In addition, the dissolve these poly(alkylene oxide) in the aqueous solution, it is desired that hydrophilic poly(alkylene oxide) is contained in the mixture in an amount of 30 to 60%.

It is desired that the template and fine particles 20 are mixed in such a manner that the molar ratio of the fine particles 20 with respect to the template (fine particles/template) is not greater than 20, and more preferably not greater than 10.

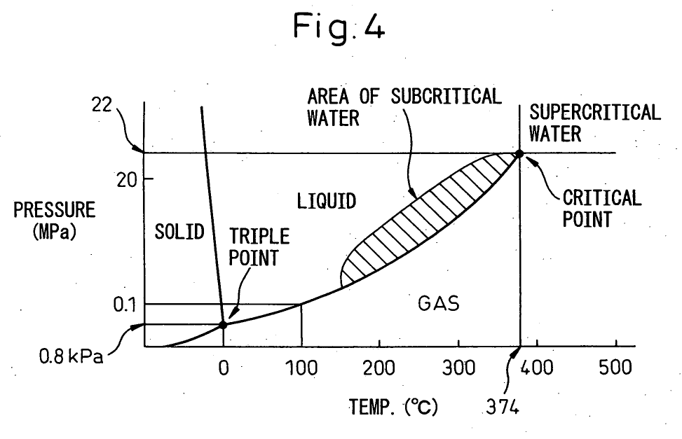

Heating and pressurization of the aqueous solution 200 produces a subcritical water state of the water in the aqueous solution 200. As explained above, subcritical water is hot water at low pressure and at a temperature near the critical point. FIG. 4 is a state diagram for water showing the subcritical water area.

The subcritical water treatment whereby the water in the aqueous solution 200 is brought to a subcritical state is carried out by hydrothermal synthesis treatment, ultrasonic irradiation or microwave irradiation of the aqueous solution 200. For hydrothermal synthesis, the aqueous solution 200 is placed in a pressure-resistant vessel and heated to, for example, about 180° C.

For ultrasonic irradiation, an ordinary ultrasonic wave generator is used for irradiation of the aqueous solution 200 with ultrasonic waves, and the impact energy produced by bursting of the air bubbles generated thereby locally creates a subcritical water state in the aqueous solution 200.

For microwave irradiation, a commercially available microwave apparatus or the like is used to irradiate the aqueous solution 200 with microwaves in the same manner as carried out with an ordinary microwave oven, for example, and the bombardment is utilized to locally create a subcritical water state.

Thus, presumably subcritical water treatment forms a precursor 40 comprising the template 30 and fine particles 20 integrated in the aqueous solution 200, as shown in FIG. 3B.

This is attributed to the fact that fine particles 20 are present in the pores 11 of the mesoporous body 10 when subcritical water treatment is carried out, whereas no fine particles 20 are present in the pores 11 when no subcritical water treatment is carried out, as will be demonstrated by the examples and comparative examples described hereunder.

Next, as shown in FIG. 3C, the aqueous solution 200 is then returned to room temperature and atmospheric pressure, and a mesoporous body 10 starting component 1 such as tetraethyl orthosilicate (TEOS), for example, is dissolved in the aqueous solution 200 containing the precursor 40 and heated.

This causes the starting component 1 to undergo hydrolysis so that the starting component 1 adheres around the precursor 40, as shown in FIGS. 3D and 3E, while self-assembly simultaneously begins due to the template 30, causing aggregation of the precursor 40.

Precipitation of the aggregated precursor 40 in the aqueous solution 200 results in formation of a precipitate containing the template 30, fine particles 20 and mesoporous body 10 starting material.

The precipitate is separated and then dried and fired to burn off the template 30 in the precipitate. This produces pores 11 as the spaces where the template has burned off, leaving the fine particles 20 in the pores 11 and resulting in a mesoporous structure 100 as shown in FIGS. 1A and 1B.

According to this embodiment, therefore, the process for production of a mesoporous structure 100 wherein fine particles 20 are situated in the pores 11 of the mesoporous body 10 formed by the template method allows the fine particles 20 to be efficiently situated in the pores 11 without creating a reversed micelle state.

An aqueous solution is obtained as a mixture of the template 30 and fine particles 20 in the production process of this embodiment, but preferably an envelopment accelerator is added to the aqueous solution. The envelopment accelerator is a molecule having a functional group that attracts the template 30 by hydrophobic interaction and a functional group that attracts the fine particles 20 by electrostatic attraction.

By also adding such an envelopment accelerator, the effect of the envelopment accelerator of attracting the template 30 and fine particles 20 facilitates incorporation of the fine particles 20 into the template 30. This facilitates formation of the precursor 40 wherein the template 30 and fine particles 20 are integrated, thereby allowing the fine particles 20 to be efficiently situated in the pores 11.

The functional group that attracts the template 30 by hydrophobic interaction in the molecule of the envelopment accelerator, may be, for example, an alkyl group such as methyl, butyl or propyl, while the functional group that attracts the fine particles 20 by electrostatic attraction may be, for example, carboxyl, amino, carbonyl, hydroxyl, ether or the like.

The envelopment accelerator is composed of a molecule possessing such a functional group, and as specific examples there may be mentioned acetic acid, acetone, n-butylamine and PO70-EO20-PO70. The molar ratio of the fine particles 20 and the envelopment accelerator is preferably no greater than 40 for the envelopment accelerator with respect to 1 for the fine particles 20.

### EXAMPLES

A process for production of a mesoporous structure according to the invention will now be explained in greater detail with reference to the following examples and comparative examples, although these are not limitative. The mesoporous structures prepared in the following examples may be applied for various types of catalysts.

### Example 1

In this example, EO20-PO70-EO20 was used as the template, while Ce oxide with a particle size of about 4 nm and exhibiting an oxygen occluding/releasing function was used as the fine particles.

The fine particles were dispersed in purified water, and hydrochloric acid was added to the dispersion to a pH of below 1. Next, EO20-PO70-EO20 was added to this dispersion at a pH of below 1, and then more fine particles were added while stirring to obtain an aqueous solution comprising a mixture of the template and fine particles. The weight ratio of the water, EO20-PO70-EO20 and fine particles was 120:4:1.

After thorough mixing, the aqueous solution was transferred to a pressure-resistant vessel and subjected to hydrothermal synthesis treatment at 180° C. for 24 hours, as subcritical water treatment. The aqueous solution was then returned to room temperature, atmospheric pressure, tetraethyl orthosilicate (TEOS) was added to the aqueous solution to a weight ratio of 2:1 with respect to the template, and hydrothermal synthesis was repeated at 100° C. for 24 hours in the pressure-resistant vessel to obtain a precipitate.

The precipitate was removed from the pressure-resistant vessel and dried, and then fired at 600° C. to burn off the template, to obtain a mesoporous structure comprising fine particles made of Ce oxide with a particle size of about 4 nm, situated in the pores of a mesoporous body made of silica.

### Example 2

The same procedure was carried out as in Example 1, except that the subcritical water treatment consisted of irradiation with ultrasonic waves for 2 hours at a frequency of 25 kHz, to obtain a mesoporous structure comprising fine particles made of Ce oxide with a particle size of about 4 nm, situated in the pores of a mesoporous body made of silica.

### Example 3

The same procedure was carried out as in Example 1, except that the subcritical water treatment consisted of microwave irradiation for 10 hours using a microwave apparatus, to obtain a mesoporous structure comprising fine particles made of Ce oxide with a particle size of about 4 nm, situated in the pores of a mesoporous body made of silica.

### Example 4

The same procedure was carried out as in Example 1, except that the fine particles used were made of a Ce—Zr oxide solid solution (Ce:Zr=70:30) with a particle size of 4 nm, as a solid solution with an oxygen occluding/releasing function, to obtain a mesoporous structure comprising fine particles situated in the pores of a mesoporous body made of silica.

### Example 5

The same procedure was carried out as in Example 1, except that the fine particles used had a core composed of a Ce—Zr oxide solid solution with a particle size of 4 nm, as a solid solution with an oxygen

occluding/releasing function, and a covering layer of Pt and Rh formed on the outer perimeter thereof, to obtain a mesoporous structure comprising fine particles situated in the pores of a mesoporous body made of silica.

### Example 6

The same procedure was carried out as in Example 1, except that the fine particles used were made of Ti oxide with a particle size of 4 nm, to obtain a mesoporous structure comprising fine particles situated in the pores of a mesoporous body made of silica.

### Example 7

The same procedure was carried out as in Example 1, except that the fine particles used were made of Zr oxide with a particle size of 4 nm, to obtain a mesoporous structure comprising fine particles situated in the pores of a mesoporous body made of silica.

### Example 8

In this example, EO20-PO70-EO20 was used as the template, Ce oxide with a particle size of about 4 nm and having an oxygen occluding/releasing function was used for the fine particles, and acetic acid was used as an envelopment accelerator.

The fine particles were dispersed in purified water, and hydrochloric acid was added to the dispersion to a pH of below 1. Next, EO20-PO70-EO20 was added to this dispersion at a pH of below 1, and then more fine particles and acetic acid were added while stirring to obtain an aqueous solution comprising a mixture of the template, fine particles and acetic acid. The weight ratio of the water, EO20-PO70-EO20, fine particles and acetic acid as the envelopment accelerator was 120:4:1:2.

After thorough mixing, the aqueous solution was transferred to a pressure-resistant vessel and subjected to hydrothermal synthesis treatment at 100° C. for 24 hours, as subcritical water treatment. The aqueous solution was then returned to room temperature, atmospheric pressure, tetraethyl orthosilicate (TEOS) was added to the aqueous solution to a weight ratio of 2:1 with respect to the template, and hydrothermal synthesis was repeated at 100° C. for 24 hours in the pressure-resistant vessel to obtain a precipitate.

The precipitate was removed from the pressure-resistant vessel and dried, and then fired at 600° C. to burn off the template to obtain a mesoporous structure comprising fine particles made of Ce oxide with a particle size of about 4 nm, situated in the pores of a mesoporous body made of silica.

### Example 9

The same procedure was carried out as in Example 8, except that acetone was used as the envelopment accelerator, to obtain a mesoporous structure comprising fine particles situated in the pores of a mesoporous body made of silica.

### Example 10

The same procedure was carried out as in Example 8, except that n-butylamine was used as the envelopment accelerator, to obtain a mesoporous structure comprising fine particles situated in the pores of a mesoporous body made of silica.

### Example 11

The same procedure was carried out as in Example 8, except that PO70-EO20-PO70 was used as the envelopment accelerator, to obtain a mesoporous structure comprising fine particles situated in the pores of a mesoporous body made of silica.

### Example 12

The same procedure was carried out as in Example 1, except that EO20-BO70 (butylene oxide)-EO20 was used as the template, to obtain a mesoporous structure comprising fine particles situated in the pores of a mesoporous body made of silica.

It was confirmed from the TEM observation that the proportions of the fine particles situated in the mesoporous structures were increased in Examples 8 to 12, compared to the mesoporous structures prepared in Examples 1 to 7. Further, it was confirmed in Example 12 that the size of pores and the proportion of the fine particles were increased, compared to the mesoporous structure of Example 1.

### Comparative Example 1

The template EO20-PO70-EO20 was added to water prepared to a pH of below 1, and fine particles composed of Ce oxide with a particle size of about 4 nm and tetraethyl orthosilicate (TEOS) were added while stirring. The weight ratio of the water, EO20-PO70-EO20, fine particles and TEOS was 120:4:1:8.

After thorough mixing, the aqueous solution was transferred to a pressure-resistant vessel and subjected to hydrothermal synthesis at 100° C. for 24 hours. After then removing the solution from the pressure-resistant vessel, it was dried to separate the product and firing was performed at 600° C. to burn off the template and produce a mesoporous structure made of silica.

TEM observation was carried out to confirm the pore shapes of the mesoporous structures produced in the examples and comparative examples, as well as the states of the fine particles in the pores.

In the examples described above, aligned pores with sizes of 8-9 nm were observed, whereas the mesoporous structures produced in the comparative examples were found to have numerous aggregated fine particles which were not enveloped in the pores, while some of the pores were also only partially formed.

Also, for the examples, a cross-section of each mesoporous structure was taken by ion milling and observed by TEM, whereby fine particles were found to be enveloped in the pores of the mesoporous structures, thus confirming that the fine particles were actually located in the pores. In the comparative examples, however, fine particles were substantially absent from the pores.

The following test was also conducted to confirm the hydrothermal durability of the mesoporous structures produced in the examples. Each obtained mesoporous structure was molded into a pellet and loaded into a tubular furnace. Next, a steam atmosphere of 900° C. was created inside the furnace and sustained for 5 hours. After the test, the pelletized mesoporous structure was crushed and observed by TEM.

This test confirmed the same pore shapes for the examples as before the hydrothermal durability test. In other words, the mesoporous structures of the examples maintained their pore shapes even in a steam environment of 900° C. The examples also had pore wall thicknesses of 3 nm or greater.

That is, by adjusting the hydrothermal synthesis conditions (temperature, time) and the conditions for ultrasonic irradiation or microwave irradiation in the production process described above, it is possible to control the thickness of the pore walls to achieve pore wall thicknesses of 3 nm or greater, and to thereby maintain the three-dimensional structure of the mesoporous body up to a temperature of 900° C.

In order to achieve a pore wall thickness of at least 3 nm, the template is preferably selected for the production process so that the polymerization degree of the hydrophilic portion including poly(ethylene oxide) (EOx) is 20 or greater.

### Other Embodiments

Since hydrolysis of a metal alkoxide such as TEOS is employed when the precursor comprising the integrated template and fine particles is converted to the mesoporous body starting material, subcritical water that exhibits a powerful hydrolysis effect may also be used when forming the pore walls made of silica. Also, hydrothermal synthesis, ultrasonic waves and microwaves may be used in the same manner as the means for forming the subcritical water.

Incidentally, although an ordinary amphiphilic poly(alkylene oxide) block copolymer such as the triblock copolymer (EOx-POx-EOx) was mentioned as the template in the examples described above, the template is not particularly restricted so long as it can be employed in the template method.

1. A process for production of a mesoporous structure wherein fine particles having a mean particle size smaller than the size of pores of a mesoporous body formed using a template are formed in the pores of said mesoporous body, the process comprises:
preparing an aqueous solution comprising a mixture of the template and the fine particles,
heating and pressurizing the aqueous solution to bring the water in the aqueous solution to a subcritical water state,
returning the aqueous solution to a state at a room temperature and under atmospheric pressure,
dissolving a starting material of the mesoporous body in the aqueous solution and heating it to form a precipitate comprising the template, fine particles and starting material of the mesoporous body, and
separating, drying and firing the precipitate to burn off the template from the precipitate.

2. A process according to claim 1, in which the water in the aqueous solution is brought to a subcritical water state by hydrothermal synthesis, ultrasonic irradiation or microwave irradiation of the aqueous solution.

3. A process according to claim 1, in which an amphiphilic poly(alkylene oxide) block copolymer is used as the template.

4. A process according to claim 3, in which the poly(alkylene oxide) block copolymer has a molecular weight of not less than 1,000.

5. A process according to claim 3, in which the poly(alkylene oxide) block copolymer contains hydrophilic poly(alkylene oxide) in an amount of 30 to 60%.

6. A process according to claim 3, in which said block copolymer comprises one or more block copolymers selected from the group consisting of triblock copolymers having hydrophilic poly(alkylene oxide) covalently bonded to the opposed ends of hydrophobic poly(alkylene oxide), and diblock copolymers having hydrophobic poly(alkylene oxide) covalently bonded to the end terminal of hydrophilic poly(alkylene oxide).

7. A process according to claim 6, in which hydrophilic poly(alkylene oxide) is poly(ethylene oxide).

8. A process according to claim 6, in which hydrophobic poly(alkylene oxide) is selected from the group consisting of poly(propylene oxide), poly(butylene oxide), poly(phenylene oxide) and polyhydroxylic acid.

9. A process according to claim 8, in which hydrophobic polyalkylene oxide is polyhydroxylic acid, and hydroxylic acid is selected from the group consisting of glycolic acid, lactic acid, malic acid, tartaric acid and citric acid.

10. A process according to claim 1, in which the molar ratio of the template and fine particles in the aqueous solution comprising the mixture of the template and fine particles is not greater than 20 for the fine particles with respect to 1 for the template.

11. A process according to claim 10, in which the molar ratio of the template and fine particles is not greater than 10 for the fine particles with respect to 1 for the template.

12. A process according to claim 1, which further comprises the step of adding a molecule with a functional group that attracts at each other the template by hydrophobic interaction and a functional group that attracts at each other the fine particles by electrostatic attraction, to the aqueous solution comprising the mixture of the template and fine particles.
